(19) United States
(12) Patent Application Publication
(10) Pub. No.: US 2002/0069674 A1
(43) Pub. Date: Jun. 13, 2002

(54) Methods and apparatus for automated manufacture of optical fiber

(76) Inventors: Patricia C. Guy, Wilmington, NC (US); Patti A. Henderson, Wilmington, NC (US); William J. Kish, Wilmington, NC (US); Emanuel Miliotis, Wilmington, NC (US); Bruce W. Reding, Wilmington, NC (US)

Correspondence Address: CORNING INCORPORATED, SP-TI-3-1, CORNING, NY, 14831

(21) Appl. No.: 09/735,780

(22) Filed: Dec. 13, 2000

(51) Int. Cl. C03B 37/07

(52) U.S. Cl. 65/377; 65/484; 65/485; 65/378

(57) ABSTRACT

A method and apparatus for automated manufacturing of optical fiber. According to one embodiment of the invention, an automated conveyor system automatically moves spools of optical fiber from one manufacturing process step to another. The spools are preferably mounted on pallets which circuit around on a plurality of non-interconnected track segments. The segments may include, for example, a segment transporting spools from draw, one or more test segments, and a shipping segment. Data-containing devices are mounted to the spool or pallet and allow data to be uploaded, downloaded and transferred as the fiber on the spool is processed and tested.

### FIELD OF THE INVENTION

The present invention relates generally to methods and apparatus for the manufacture of optical fiber. More specifically, the present invention relates to methods and apparatus for automating processing of optical fiber.

### BACKGROUND OF THE INVENTION

In the current manufacturing process for optical fiber, optical fiber is typically wound onto a spool at a draw tower, measured and tested at another department, and shipped to a customer, usually with subsequent processing at the customer's facility. Movement from the draw is manual, by placement on carts that are manually moved to a test station. The measurement and testing of optical fiber is currently performed manually by multiple technicians, with carts carrying a number of spools being manually moved from test station to test station. At a test station a technician removes a spool from the cart and places the spool on a measurement rack. The technician then strips and removes the plastic fiber coating from both ends of the optical fiber, cleaning off excess coating and any remaining debris. The fiber ends are manipulated by the technician into a cleaver and cut. Next, the technician loads the fiber ends into a computer controlled measurement system and initiates a measurement sequence to test at least one characteristic of the optical fiber, e.g., fiber cutoff wavelength, attenuation, fiber curl, cladding diameter, or coating diameter, for example. The fiber is then removed from the testing system and the spool returned to the cart. All of the spools on the cart or only selected spools may be tested as desired. The cart is then manually moved to the next test station for another of the series of tests. Following this, the fiber spools are manually moved to the shipping department and packed in appropriate packaging for shipment to the customer. The amount of manual labor involved results in high labor costs and high manufacturing costs for the optical fiber. Moreover, the time from draw to testing is long enough that feedback measurements within the system are sometimes too late to make adequate corrections.

Accordingly, it would be highly advantageous to reduce the cost of, and time to, manufacture optical fiber. Furthermore, it would be desirable to provide faster feedback to the fiber draw processes. Additionally, it would be highly advantageous to reduce the opportunity for human error and provide a more repeatable process.

### SUMMARY OF THE INVENTION

The present invention provides advantageous methods and apparatus for the automation of the processes for production of optical fiber. The present invention includes an automated conveyor system that automatically moves wound spools of optical fiber preferably contained on pallets from one step in the manufacturing process to another. For example, in a preferred embodiment, the spools are automatically moved from the fiber draw tower or towers transferred between various independent and automated track segments where various operations are performed readying the wound spools for shipment.

In accordance with a first embodiment, the spools are transferred from one or more draw towers to a first segment of the automated system. The spools are transferred to the segment by at least one, and more preferably by a plurality of, transfer apparatus. The spools may be either bulk or shipping spools. The spools are then preferably transferred to a second track segment, such as a test segment where one or more tests may be performed on the fiber. According to a preferred embodiment, the test includes at least one or, more preferably, a plurality of optical tests on the wound fiber. In accordance with another embodiment, a tensile test may be performed. Further, the fiber, if wound on bulk spools, may be rewound onto shipping spools at stations on one of the track segments.

In accordance with another embodiment of the invention, the pallets or spools include a data-containing device such as an electronic RF chip. Data concerning the spool, the fiber, and their processing may then be carried along throughout the various production processes and downloaded, uploaded, or transferred as desired. Thus, fast access to information concerning the fiber and its status is readily available throughout the process.

According to another embodiment of the invention, the spools are transferred to another track segment, such as an automated shipping segment, by another transfer apparatus. At the shipping segment, final operations may be performed on the shipping spools, such as shrink wrapping, placing covers on the spools, labeling and sorting. Finally, a loading apparatus preferably automatically loads the fiber into a shipping package.

Advantageously, the present invention enables manufacture of optical fiber at rates heretofore not achievable. The time from the beginning of the process to the end is dramatically reduced. Moreover, the quality of the fiber may be enhanced and the feedback to the fiber draw process is much more readily obtained. These and other features, aspects and advantages of the invention will be apparent to those skilled in the art from the following detailed description taken together with the accompanying drawings.

### BRIEF DESCRIPTION OF THE DRAWINGS

FIG. 1 illustrates a graphic depiction of the automated draw and a partial view of the automated conveyor system in accordance with the invention.

FIG. 2 illustrates a graphic depiction of the automated conveyor system in accordance with the invention.

FIG. 3 illustrates a more detailed graphic depiction of a testing segment according to the invention.

FIG. 4 illustrates a graphic depiction of a shipping segment according to the invention.

FIG. 5 illustrates a graphic depiction of another embodiment of the automated conveyor system in accordance with the invention.

### DETAILED DESCRIPTION OF THE PREFERRED EMBODIMENT

The present invention now will be described more fully with reference to the accompanying drawings, in which several currently preferred embodiments of the invention are shown. However, this invention may be embodied in various forms and should not be construed as limited to the exemplary embodiments set forth herein. Rather, these representative embodiments are described in detail so that this disclosure will be thorough and complete, and will fully convey the scope, structure, operation, functionality, and potential of applicability of the invention to those of ordinary skill in the art.

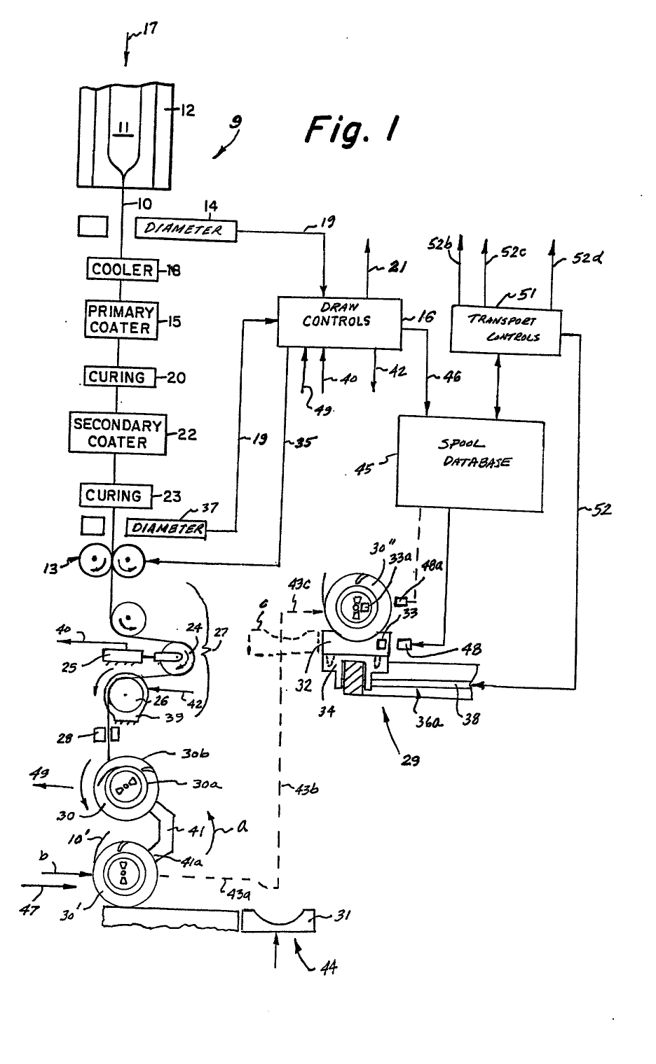

Referring to the drawings, FIG. 1 illustrates a graphical depiction of the draw apparatus 9 and a partial section of the conveyor system 29 in accordance with the present invention. The draw apparatus 9 produces a supply of optical fiber and automatically winds the fiber onto spools 30. In accordance with conventional practice, a consolidated glass preform 11 is heated in a draw furnace 12 to a temperature whereby the tip of the preform 11 turns molten and a fiber 10 is drawn therefrom. The fiber 10 passes through a non-contact diameter sensor 14 where its diameter measurement, provided in line 19, is checked against a predetermined desired set diameter programmed into memory of the draw controls 16. Draw controls 16 may control the down feed rate 17 of the preform 11 and the draw rate of the fiber 10 controlled by the draw tension supplied by a draw tension mechanism 13 (shown as interacting capstans).

The down feed rate 17 is set based upon a down feed signal 21 sent to a down feed motor (not shown) to impart the proper downward motion to the preform 11 to pass it through a hot zone in the furnace 12. Furthermore, the draw controls 16 produce a draw signal in line 35 that controls the draw rate of a motor (not shown) of the draw tension mechanism 13. The draw tension force may be provided by any suitable mechanism (usually two interacting capstans which grip the fiber) that imparts a tension force onto the fiber 10 to draw it from the preform 11 at the desired rate thereby maintaining the proper fiber diameter.

A cooler or coolers 18, usually tubes including an inert cooling gas such as helium, may be provided where the fiber 10 is cooled sufficiently such that a first coating of a suitable polymer, such as UV curable coating, may be applied at primary coater 15. The coating is then cured by one or more ultraviolet radiation producing apparatus at curing step 20. Secondary coater 22 shown may be utilized to apply a secondary UV curable polymer protective layer. Secondary coating is likewise cured by one or more curing apparatus 23. Diameter sensor 37 may be utilized to check the amount of coating applied by sending signal, in line 19, to the draw controls 16. The coating thickness may then be suitably adjusted, if required.

After passing through the tension mechanism 13, the fiber 10 passes through an on-draw tensile tester 27. The on-draw tensile tester 27 applies a preset tensile force to the fiber 10 by way of, for example, a driving a motor 39 rotating a capstan 26 with slightly more torque than tension mechanism 13. The torque applied is predetermined based upon the desired strength of the fiber 10. The tension test torque applied is based upon drive input to motor 39 in line 42 (shown as two arrows for clarity) from draw controls 16. A load cell 25 mounted to a fixed frame on one end and to a rotating capstan on the other measures the force applied to capstan 24 and feeds the feedback force information to the draw controls via line 40 (also shown as two arrows for clarity). Thus it should be recognized that within the draw controls 16, data may be received, stored and generated regarding tensile load applied to the fiber 10, fiber and coating diameters, down feed rate, draw speed, draw rate, fiber length, etc. This data may be transferred to and stored in one or more databases 45 via transfer line 46. It should be understood that, in a preferred embodiment, there may be multiple draw controls, for example, one for each draw tower and a common master database 45. Alternatively, there may be several databases which store certain data only.

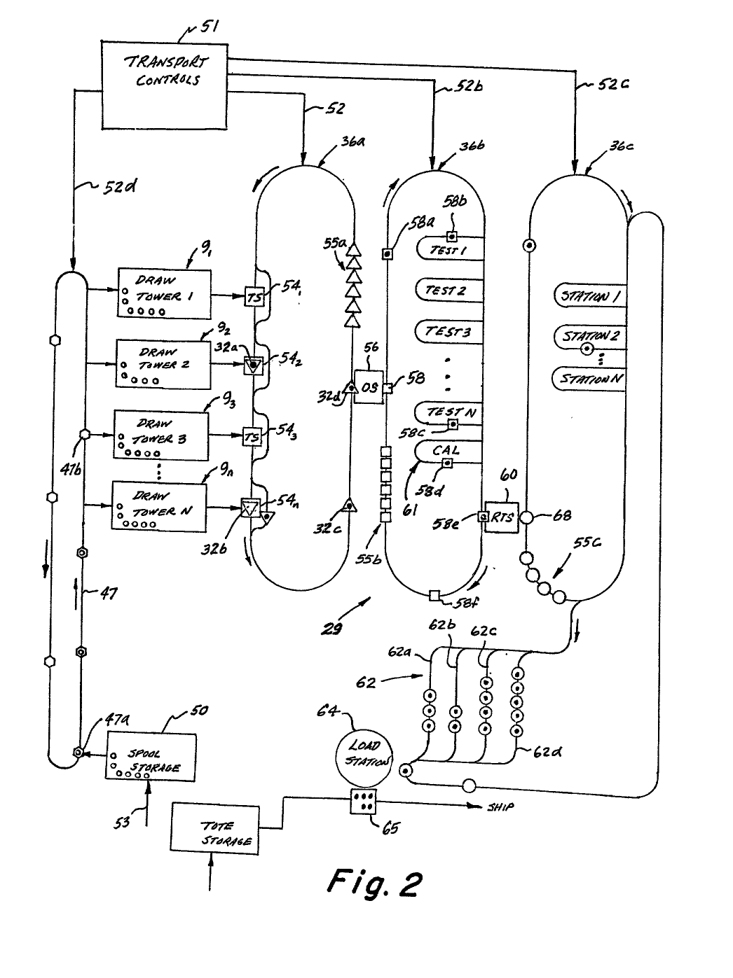

In accordance with one embodiment, the fiber 10 is automatically wound onto a shipping spool 30 by controlling the back and forth motion of a reciprocating feed head 28 through which the fiber passes. This causes sequential winding of fiber 10 onto both the lead meter portion 30a and the main body portion 30b of the spool 30. The lead meter portion 30a generally includes a separate spool attached to one flange of the spool 30 and onto which a short segment of fiber 10 is wound which is used for later testing purposes. The fiber on the main body 30b is utilized by the customer and comprises the bulk of the wound fiber. It should be recognized that the fiber is preferably wound directly onto a spool 30 that is shippable directly to the customer. As soon as the draw controls 16 have determined that a desired length of fiber 10 is wound onto the spool 30 or that the fiber process has experienced a break, a pivoting spool rotator mechanism 41 including a motor drive (not shown) causes a new spool 30′ to be rotated onto place (as indicated by arrow A) and winding is immediately commenced thereon. The new spool 30′ has been previously preferably automatically mounted onto the mechanism 41 from a continuous supply of identical new spools 30′ from spool supply 47 (see FIG. 2). Data regarding length of the fiber and whether a break occurred is sent to the draw controls 16 or the database 45 in lines 46, 49.

Prior to installation of the new spool on the first end 41a of the mechanism 41, the wound spool must be removed. If the winding was finished in its normal course due to having the appropriate length of fiber 10 wound thereon, then the fiber 10′ between the lead meter portion 30a of the spool 30 and the just wound spool 30′ is cut. The cutting may be accomplished by any suitable cutting mechanism, such as an automated scissors mechanism. The spool 30′ is then removed from the mechanism 41 by a robot or other suitable automated mechanism and is pushed or otherwise moved as indicated by arrow “b” to an intermediate platform 31 along dotted line 43a. This movement to the intermediate platform 31 is preferably accomplished by the same robot or other automated mechanism utilized to load the empty spool.

The platform 31 is part of an elevator apparatus 44 which moves the wound spool 30′ upward along segment 43b to an elevated position at platform position “c” (shown as dotted). The spool 30′ is then transferred onto an awaiting pallet 32 along the direction of segment 43c. The wound spool, now designated as 30″ for clarity, is moved onto pallet 32 from the intermediate platform 31 at position “c” by any suitable means such as just described, for example, by a robot or other mechanized pusher mechanism. Thus, according to one aspect of the invention, a method of winding optical fiber onto shipping spools is provided, then followed with a method and apparatus for unloading such wound spools and loading them onto an automated conveyer system 29 in accordance with the invention. Preferably, the draw apparatus 9 includes on-line tensile screening where the test for tensile strength is performed before winding the fiber onto the shipping spool 30. Such tensile screening may be accomplished off-line as will be described later herein.

According to a preferred embodiment, the tracks of the automated conveyor system 29 are placed overhead in the factory such that they do not get in the way of other production operations and do not impeded movement of operators within the factory. The elevator system 44 functions to transport the fiber spool from the level of the spool winder apparatus up to the level of the conveyor system 29. Preferred track components utilized in accordance with the present invention are manufactured by Montrac LLC of Charlotte, N.C.

Again referring to FIG. 1, the pallet 32 is attached to, or integral with, a moveable truck 34 which rides on a track segment 36a (a segment portion of which is shown) of the automated conveyor system 29. Shown mounted on the pallet 32 of the conveyor system 29 is the previously wound spool 30″. This spool 30″ is now ready for automated transport to the next step in the manufacturing process, i.e., fiber testing. It should be recognized that the track segment 36a is part of a circuit feeding wound spools from multiple draw apparatus (see FIG. 2). The pallets used may made in any desired shape and preferably include a groove therein to accept the spool and limit its movement. Optionally, cushioning may also be provided. Moreover, the track segment may be configured to any desired shape to fit the location of the equipment and facility boundaries.

Transport controls 51 are preferably utilized to control the movement of the trucks 34 and, thus, the pallets 32 and spools on the automated conveyor system 29. Movement control is accomplished by various control signals 52 provided to strips 38 mounted on the track segments (e.g., segment 36a). It should be recognized that the transport controls 51 control the movement of all the pallets (and thus all the spools) within at least one track segment. A common control system is may be employed for controlling the movement of all pallets in the system 29. Arrow labeled 52b, 52c, 52d indicate that the controls 51 control all track segments 36a, 36b, 36c and 47. Optionally, separate transport controls may be used to control pallet flow in other track segments (e.g., 36b, 36c, 47).

At some point in the manufacturing process, preferably between being off loaded from the spool rotator mechanism 41a and being placed on the pallet 32, each spool is assigned a tracking identification code (such as a number or alphanumeric) for tracking and identification purposes. For each wound spool, further data may be down loaded from the draw controls 16 or otherwise generated and transferred to the spool database 45 via interaction line 46. For example, the data downloaded into the database 45 regarding each wound spool may, for example, include identification, instructional and/or performance and other data for the spool such as the following:

a) spool identification code,

b) type of spool,

c) destination of spool,

d) date and time,

e) fiber type,

f) draw end time of spool,

g) draw number,

h) event code,

i) length of fiber on the spool,

j) at risk length,

k) payout length,

l) average diameter,

m) high or low diameter,

n) statistical variation in diameter,

o) intended recipient customer,

p) tension applied to fiber on spool, and/or

q) draw tower of origin.

The representative data for each spool may be downloaded from database 45 or viewed, printed and/or edited at various stations visited during the production process. Certain data may be downloaded after draw by way of a sending transducer 48 transferring the desired data onto a data containing device 33 such as a Radio Frequency (RF) chip. The data containing device 33 preferably resides on, and is mounted to, the pallet 32 and is preferably adapted to contain and store bits of information in digital form. Alternatively, a RF chip 33a may be mounted on any convenient part of the spool 30″ such as on a flange of the spool. In this scenario, the desired data may be downloaded from the database via transducer 48a. According to another embodiment, the RF chip may reside on the truck 34 or any other system apparatus that will move along with the spool. RF chips are desirable because they are non-contact in operation and, thus, no manual operation is required to download the desired information. All that is required is a sending unit in the proximity of the data containing device 33, 33a. However, it should be recognized that any type of electronic or magnetic data containing device may be employed. Thus, in accordance with this embodiment of the invention, the pertinent data resides in a data containing device associated with the respective spool and is carried along with the spool as it progresses through the manufacturing process. Other data may be stored in a master spool database 45 and downloaded, viewed, printed, transferred or otherwise utilized elsewhere in the manufacturing process, when needed.

The interaction and flow of wound fiber spools from each of the plurality of draw towers 9₁, 9₂, 9₃, . . . 9_{N} within the automated manufacturing process is best illustrated in FIG. 2. Moreover, the orientation and relationship of the plurality of track segments 36a, 36b, 36c is illustrated. As can be seen in FIG. 2, each segment 47, 36a, 36b, 36c has pallets (designated as hexagons, triangles, squares, and circles, respectively) thereon. Each pallet is designed for the particular segment it operates upon. Pallets for each segment are not transferred to another segment, but continue to circuit around their particular track segment. It is the spools that are transferred between the track segments in accordance with the invention. This enables simple construction of the pallets when needed (for example, in the shipping segment 36c) and more sophisticated pallet in those segments where required (in the testing segment 36b, for example).

Provided to each of the towers 9₁, 9₂, 9₃, . . . , 9_{N} from spool supply 47 are a continuous or intermittent supply of new or reconditioned spools from the spool storage 50. As shown, the spool carrier pallets (shown as hexagons) are continually or intermittently moving around on the supply loop 47. For example, carrier pallet 47a is in a position where an empty shipping spool (designated as an unfilled circle positioned within the hexagon) is being loaded onto the carrier pallet from a supply of stored spools 50. Carrier 47b is in a position where an empty spool has just been unloaded to draw tower 3, for example. Thus, it should be recognized that the supply 47 provides empty spools to each of the draw towers. Staging preferably occurs at each draw tower 9₁, 9₂, 9₃, . . . , 9_{N} where an oversupply of a plurality of empty spools (shown as unfilled circles) are stored at each tower and available at all times. From the oversupply, spools are loaded as needed, preferably automatically, onto the spool rotator mechanism 41 (FIG. 1). Optionally, there may be a central staging area for all the spools supplied to the draw towers or the spools may be provided from the spool storage on an as-needed basis. Spool storage 50 is periodically supplemented with new or reconditioned spools at empty spool inflow 53.

Transfer stations 54₁, 54₂, 54₃, . . . , 54_{N} perform the function of transferring the wound spools (designated as filled circles inside of the triangles) from the respective ones of the plurality of draw towers 9₁, 9₂, 9₃, . . . , 9_{N} onto the pallets (designated as triangles) traversing around transfer track segment 36a. The transfer segment 36a receives the wound spools from the plurality of draw towers. The transfers stations 54₁, 54₂, 54₃, . . . , 54_{N}, depicted as the larger squares (some of which are labeled TS), preferably perform numerous functions. For example, at the transfer stations, the spool off loading function where the wound spools are offloaded from the respective draw tower may be performed. Additionally, the elevator function (if utilized) may be performed to raise the wound spools to the height of the transfer track segment 36a. Moreover, the function of loading the wound spool onto the stationed pallet may be performed. Thus, in one embodiment of the invention, the wound spools are transferred automatically from the respective draw tower onto the transfer track segment 36a. The transfer track segment performs the function of transferring the wound spools to another manufacturing process, such as fiber testing.

Within the transfer track segment 36a, a supply of pallets preferably await in a staging area 55a and are released by the transport controls 51 when required. Transfer stations 54₂ and 54_{N} are shown with pallets 32a just receiving a wound spool and pallet 32b ready to receive a wound spool. Bypass tracks are provided at each transfer station 54₁, 54₂, 54₃, . . . , 54_{N} such that pallets may pass by an already occupied station. Pallet 32c is shown in transit around the circuit with a wound spool loaded thereon and headed to an Offload Station (labeled OS) 56. The offload station serves the primary function of offloading the wound spools from the transfer track segment 36a onto test pallets 58 traversing about the testing track segment 36b. For example, at offload station 56, a wound spool on pallet 32d is transferred by any appropriate transfer means to the pallet 58. Preferably a robot or other automated device grasps the spool and performs the transfer.

At transfer station 56 additional operations such as bar code labeling of the spool may occur, where a label is adhered to the spool flange, for example. The bar code may be used throughout the testing track segment 36b (and possibly later in the shipping track segment 36c) to identify the spool. Any data generated while circuiting the test segment 36b may be downloaded to a spool database 45 and correlated with the spool identification code indicated by the bar code. In another embodiment, data contained on the data device 33 on pallet 32d may be downloaded into the database at the offload station 56 for later use. In another embodiment, the pallets traversing around the test track segment 36b may also carry a data containing device as hereinbefore described and certain data may be downloaded to the device at one or more of the test stations TEST 1, TEST 2, TEST 3, . . . , TEST N. Additionally, in accordance with another embodiment of the invention, data may be transferred from a data device on one pallet 32d of the transfer track segment 36a to a like data containing device on pallet 58 within the test track segment 36b. It should be recognized that the configuration of the test segment may take on any desired shape. Moreover, the number of tests employed may be more or less than those described herein. Furthermore, testing may not be required on every spool. Further, there may be multiple test segments 36b with only certain tests being employed in each segment.

Within test segment 36b shown in FIG. 2, at least one and, more preferably, a plurality of tests are performed on the fiber being carried by the automated conveyor system 29. These tests may include: Optical Time Domain Reflectometer (OTDR); dispersion at a certain wavelength, for example, at 1530-1560 nm; dispersion slope; cut off wavelength; glass-geometry such as core/clad concentricity, fiber and coating diameter, mode field diameter; bow-deflection of the fiber; gem, bend; Polarization Mode Dispersion (PMD); and/or attenuation. Additionally, functional operations may be performed, such as manually loading the two ends of the optical fiber into the test pallet 58, scanning the bar code, strip, cut and clean operations, certification of test equipment, further labeling, maintenance, rework, and/or spooled fiber final inspection. Within the test segment 36b, a plurality of specialty pallets, such as are described in U.S. Provisional Patent Application Ser. No. 60/168,111 filed Nov. 17, 1999 and entitled “Methods And Apparatus For Automation Of The Testing And Measurement Of Optical Fiber,” continuously or intermittently travel around the circuit as commanded by the transport controls 51.

For example, as shown in FIG. 2, a spool of wound fiber is being carried to the commanded test station by pallet 58a. The fiber wound on the spools carried by pallets 58b and 58c are undergoing testing at test stations TEST 1 and TEST N. Pallet 58d resides in a calibration station (labeled CAL) 61. Pallet 58d includes a spool of fiber which has been tested one or more times such that the properties of that fiber are well known. Periodically, the calibrated fiber spool on pallet 58d is commanded by the transport controls 51 to make the circuit around the test track segment 36b and undergo one or more, and preferably all, of the various tests performed within the test segment. The results of the test(s) are then compared with the recorded known values stored in a memory device such as the database 45. This aforementioned calibration sequence may be performed hourly, at each shift, or daily for example. Automatic shutdown of the test station may be commanded to occur, thereby taking the test station out of service, if the tested values are outside of a designated predetermined range of values. In accordance with an embodiment of the invention, spools destined for any out of service test station are rerouted by the transport controls 51 to backup stations that perform the identical test. The inclusion of more than one test station that performs the same test allows throughput to be maximized and allows for maintenance without shutting down the test segment. For example, test stations 1 and 2 may be both performing OTDR and dispersion tests. Preferably there are duplicates of all test stations.

The illustrated pallet 58f has just had a spool offloaded onto the shipping track segment 36c and is returning to the staging area 55b. At staging area, a plurality of pallets are preferably lined up and ready to move forward to the offload station 56 when so commanded by transport controls 51. When the appropriate tests, if any, have been satisfactorily completed, the spooled fiber, such as spool on pallet 58e is transferred onto pallet 68 traversing around shipping track segment 36c at Receipt To Stock (RTS) transfer station 60.

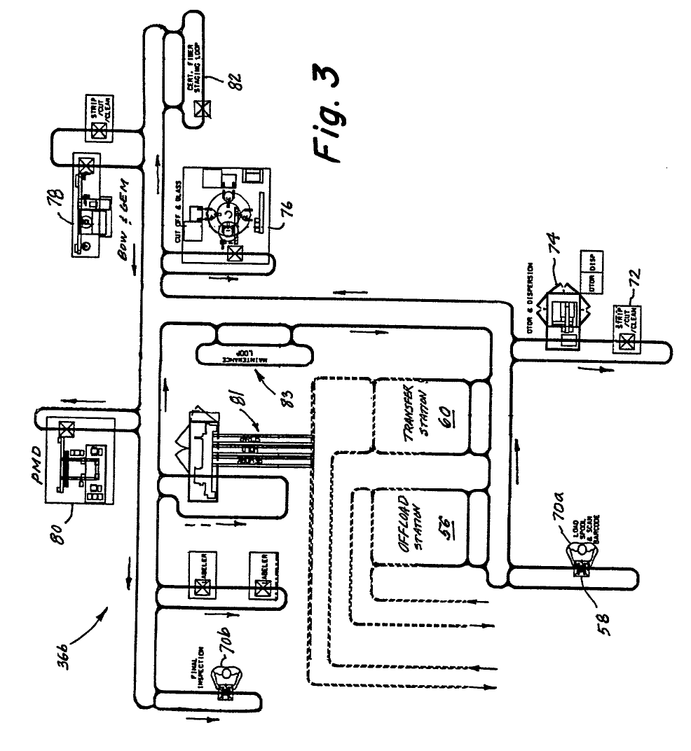

FIG. 3 illustrates one preferred layout of the test track segment 36b that may be employed in accordance with the invention. Upon being offloaded at station 56 onto the test segment 36b, the spool on test pallet 58g has the ends of the fiber from the spool manually loaded by an operator 70a into a special test pallet 58g described in the aforementioned U.S. Provisional Patent Application Ser. No. 60/168,111 filed Nov. 17, 1999. The barcode applied at the offload station 56 may also be read by the operator 70a. The pallet 58g then moves to the cut, strip and clean station 72 where both ends of the fiber are stripped of their coatings, cleaved, and cleaned. Next the pallet moves to the OTDR/dispersion station 74. OTDR (Optical Time Domain Reflectometry) and dispersion testing are automatically performed of the fiber on the spool. The OTDR testing provides a measure of the fiber attenuation of the optical fiber over a selected wavelength range. The dispersion testing provides a measure of the distortion of the optical signals as they propagate down the optical fiber. The pallet 58g and spool then move to the cutoff and glass station 76 for both the wavelength cut off and glass tests. The cutoff test measures the cutoff wavelength at which the LP11 mode will no longer significantly propagate in the fiber and the fiber propagates only the LP01 mode. Glass test examines the cross-sectional geometry of the fiber, such as the clad diameter and core/clad offset, cladding non-circularity, for example. Now the pallet 58g moves to the bow and gem test station 78 where bow and gem testing are automatically performed. The bow test is a measure of the bend or curl locked into in the fiber and is typically measured when a predetermined length of the fiber is cantilevered from a horizontal surface. Gem is a measure of the fiber's coating geometry, such as inner primary diameter, second coating diameter, offset between primary and secondary and thickness of each, etc. The end s are again stripped, cut and cleaned prior to the bow and gem operation. Next, a PMD test is performed at the PMD station 80. Final inspection is performed manually by inspector 70b. As was described before herein, a test spool of fiber with known properties is periodically released from the calibration staging area 82 to verify whether the various test stations and other operations are operating properly. Within the test segment 36b, the spools can have four dispositions: 1) pass, 2) rework, 3) hold, and 4) scrap. If the spool passes, it is sent on to the shipping track segment 36c. If the spool is deficient in some aspect, it is routed by the transport controls 51 to the defect area 81. In this area, the decisions are made relative to whether the fiber may be reworked, for example, to remove an amount of deficient fiber after which it is rerouted and transferred to the shipping segment 36c by transfer station 60. Some spools will be scrapped if not salvageable, because, for example, the properties are deficient. Other spools may be held awaiting a disposition by factory personnel. A maintenance loop 83 is also included within the test segment 36b. This loop 83 allows pallets and trucks that need maintenance to be shuttled in and out of service as required.

Again referring to FIG. 2, within the shipping track segment 36c, final manufacturing steps may take place in stations 1, 2, . . . , N, such as film wrap, labeling, adding covers, etc. Pallets (represented by small circles) carry the spooled fiber around the shipping segment 36c. At the sorting area 62, spools are sorted by properties such as product type, fiber length and fiber attribute values (attenuation, mode field diameter, geometry, cutoff wavelength, etc.) and are distributed into various lanes labeled 62a-62d. It should be understood that more or less lanes may be utilized as desired. This sorting allows fiber spools with similar properties to be readily packaged together when required. Moreover, it allows fibers with certain desired attributes or selects to be readily sorted out of the large amount of fiber produced and to be shipped to any particular customer as desired. As commanded by the transport controls 51, the wound spools, one by one, are moved adjacent to the load station 64 where they are placed into a tote 65 by a robot or other like loading mechanism. The tote 65 is a shipment package that holds approximately eight spools. Of course, totes made to package more or less spools may also be employed. “Totes” as used herein refers to any receptacle into which a spool or spools may be inserted into for packaging or shipment. Totes 65 are supplied from tote storage 67 as needed. Following closure of the tote 65, the fiber is shipped to its ultimate destination. The empty pallets circuit back to the staging area 55c. In the embodiment where the data containing device is mounted onto the spool, the customer may utilize a similar data system as hereinbefore described to read, print, display or otherwise process the data provided. This minimizes the amount of paperwork that needs to be sent along with the spooled fiber.

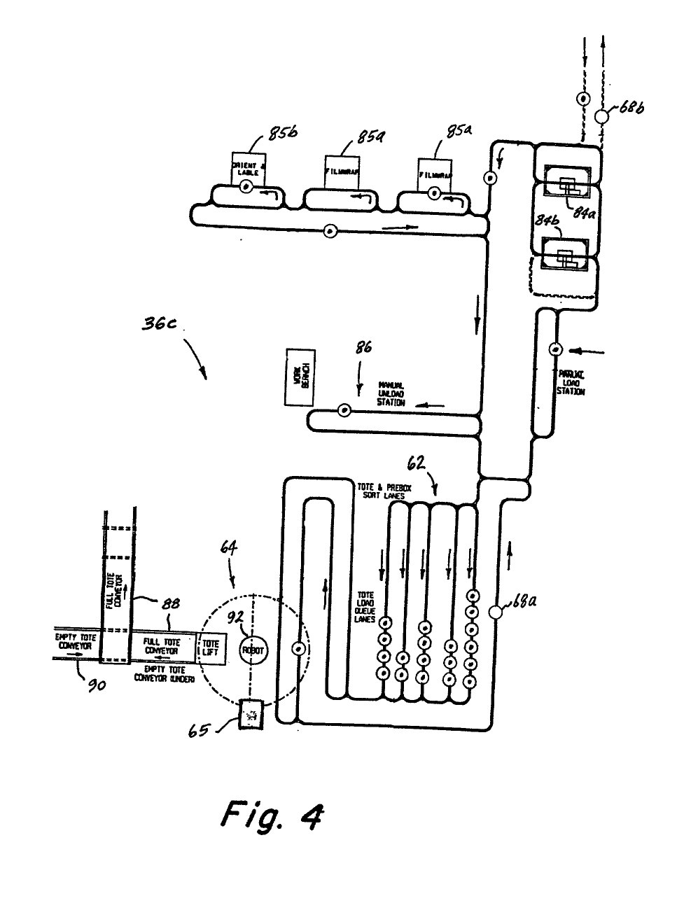

The illustrated embodiment of FIG. 4 shows one configuration of the shipping segment 36c. Pallets (shown as circles) travel from the transfer station 60 to one of two automated elevators 84a, 84b where they are lowered to the plant floor level. Then the pallets travel to various final operations such as film wrap 85a, orienting and labeling 85b, etc. If the spool does not meet certain production criteria, the pallet and spool may again be diverted to a manual unload station 86 for local rework or rejection. The various spools on pallets then travel to sort lanes 62. The particular lane the pallet enters is dependent on the properties of the fiber carried thereby. As determined by production requirements, fiber with specific predetermined properties are commanded by the transport controls 51 (FIG. 2) to be released from one or more of the lanes of the sorting area and travel to the load station 64. One by one, spools are lifted from the pallets by a robot 92 and inserted into shipping totes 65 until the desired amount of spools are loaded, afterwhich the totes move off on full tote conveyor 88. An empty tote from the empty tote conveyor 90 replaces the removed full tote and is again filled to the desired amount by the robot 92. This process repeats itself over and over again. Empty pallets such as 68a, 68b travel around the circuit and stop at a staging area located just before the transfer station.

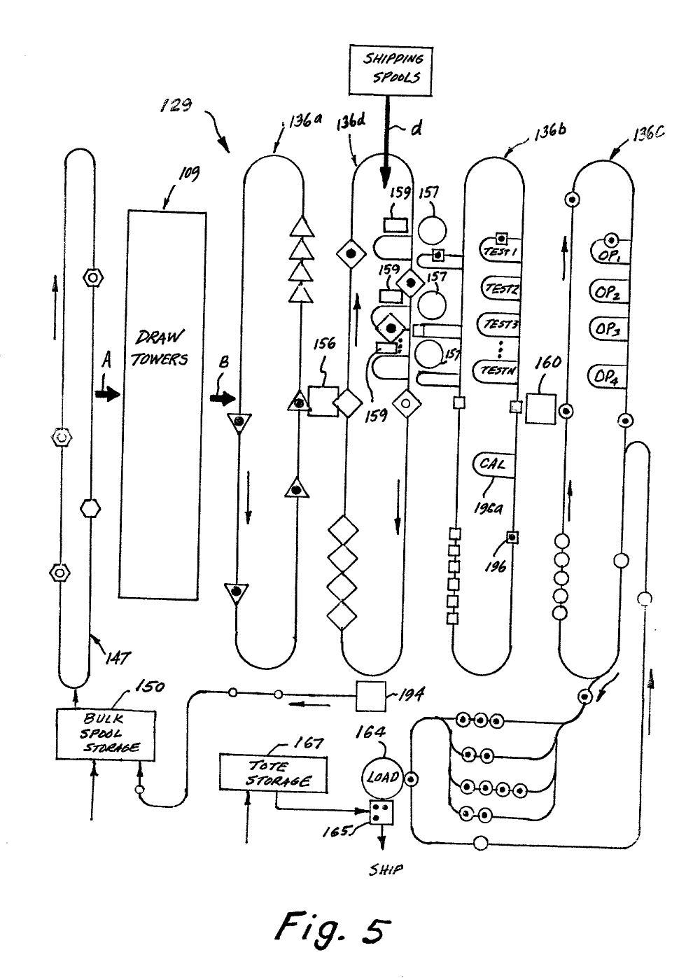

FIG. 5 illustrates another embodiment of the method and apparatus for automated manufacture of optical fiber. In this embodiment, multiple independent track segments are also included. A spool supply 147 is utilized as before described where empty spools (indicated as unfilled circles) are preferably automatically provided on pallets traversing a circuit to and from spool storage 150. Except, in this case, the spools utilized are bulk spools adapted to have wound thereon approximately 300 m or more of fiber. The bulk spools are loaded at the appropriate locations onto the respective draw towers 109 (as indicated by large arrow “A”). Thus, each tower is supplied with the needed amount of spools by the supply 147. The draw towers commence filling the bulk spools with fiber. Once filled with an amount of fiber (indicated as filled circles), the bulk spool is transferred onto the transfer track segment 136a of the automated conveyor system 129. The arrow “B” indicates that there may be multiple points of entry onto the transfer segment 136a as hereinbefore described. As before, the spools or the pallets preferably include a data containing device that carries selected data regarding the fiber on the bulk spool, etc.

The fiber wound bulk spools traverse partially around the circuit of segment 136a and are offloaded at station 156 onto a second independent track segment, the rewind segment 136d. Within this segment 136d, the fiber on the bulk spools on pallets (designated as diamonds) enter one of a plurality of rewind stations 159. At rewind station 159, the bulk spool is rewound onto smaller shipping spools having lengths adapted to carry lengths of between about 25 m and 50 m. Thus, it should be recognized that from each bulk spool, multiple shipping spools result. A continuous supply of shipping spools are provided to the rewind stations 159 as indicated by arrow “d”. During the rewind process, the fiber may be tension tested by applying an appropriate tensile load to the fiber as it is being wound onto the shipping spool. This ensures the tensile strength of the fiber shipped. The bulk spools, once emptied, continue around the circuit of segment 136d and the empty spools (indicated as unfilled circles) are offloaded at station 194 and returned to bulk spool storage 150. The tensile screened shipping spools from each station are loaded onto preferably smaller pallets (indicated as small squares) traveling around the circuit of test segment 136b preferably in an automated fashion, such as by robots 157.

Within the test track segment 136b, the spooled fiber undergoes at least one, and more preferably, a series of tests 1-N at various test stations as before described with reference to FIG. 3. Calibration of the test machines performing tests 1-N may also be intermittently or periodically performed against a calibration fiber on pallet 158e that may be housed in a calibration station 161 or which continuously loops around the test segment. Once the desired testing is complete on a particular fiber spool, the results of that test may be downloaded to a master database or downloaded to a data containing device mounted on the pallet or spool as heretofore described. At transfer station 160 the tested spools are transferred to a shipping segment 136c. Final operations may be performed on the shipping spools, such as shrink wrapping, adding covers and labeling, etc. at operation stations OP₁, OP₂, OP₃, . . . , OPₙ. After the final operations are complete, the spooled fiber is sorted in sorting area 162 of shipping segment 136c as heretofore described with reference to FIG. 2. Depending on the requirements for each tote 165 to be filled, fiber spools from one or more of the lanes of sorting area are released by the transport controls, travel to the loading station 164 and are loaded into the tote 165 thereat. Once filled, the totes are shipped to the customer. As a tote is filled, an additional tote from tote storage replaces it. This cycle repeats itself over and over. As pallets are emptied, they travel back to staging area 155c.

It will be apparent to those skilled in the art that various modifications and variations can be made in the present invention without departing from the scope of the present invention. Thus, it is intended that the present invention covers the modifications and variations of this invention provided they come within the scope of the appended claims and their equivalents.

What is claimed is:

1. A method of manufacturing optical fiber, comprising the steps of:
drawing an optical fiber from and winding the fiber on a spool at a draw apparatus,
loading the spool from the draw apparatus onto an automated conveyor system, and
moving the spool from the draw apparatus to at least one test station on the automated conveyor system, and
performing a test on the optical fiber wound onto the spool.

2. The method of claim 1 further comprising a step of transporting the spool to a shipping area on the automated conveyor system.

3. The method of claim 1 wherein the step of loading the spool from the draw apparatus is an automated operation wherein the spool is removed from a winding apparatus and is automatically placed onto the automated conveyor system.

4. The method of claim 3 comprising an additional step of automated transport of the spool to an intermediate platform.

5. The method of claim 1 wherein said spool is loaded onto a pallet mounted on the automated conveyor system.

6. The method of claim 1 further comprising an additional step of providing a data containing device on the spool or onto a pallet onto which the spool is loaded.

7. The method of claim 6 comprising an additional step of downloading data regarding the optical fiber wound onto the spool or processing performed on the optical fiber onto the data containing device.

8. The method of claim 7 wherein the data containing device is a radio frequency chip.

9. The method of claim 7 wherein the data comprises at least one piece of data selected from a group consisting of:
(a) spool identification data,
(b) type of spool,
(c) destination of spool,
(d) date and time,
(e) type of fiber,
(f) a draw apparatus the fiber was manufactured on,
(g) draw end time of spool,
(h) a draw number assigned to that draw,
(i) a code identifying a particular event,
(j) a length of fiber on the spool,
(k) a length of fiber at risk on the spool,
(l) a payout length of the fiber on the spool,
(m) an average diameter of the fiber,
(n) a high, low, average or statistical variation in fiber diameter on the spool,
(o) intended recipient customer,
(p) tension applied to fiber on spool,
(q) whether the fiber was experimental fiber,
(r) test processing instructions, and
(s) test results.

10. The method of claim 1 wherein the spool includes a data containing device mounted thereon.

11. The method of claim 1 wherein the spool is mounted upon a pallet moveable on the automated conveyor system and the pallet includes a data containing device mounted thereon.

12. The method of claim 11 wherein the data containing device moves along with the spool on the automated conveyor; the data containing device including data regarding the fiber wound on the spool.

13. The method of claim 1 comprising an additional step of downloading data regarding the optical fiber into a database.

14. The method of claim 1 further comprising providing the automated conveyor with a plurality of non-interconnected track segments.

15. The method of claim 14 further comprising an additional step of transferring the spool between at least two of the plurality of non-interconnected track segments.

16. The method of claim 14 further comprising automated removal of the spool from a first pallet circuiting a first one of the non-interconnected track segments and automated transfer to a second pallet circuiting a second one of the non-interconnected track segments.

17. The method of claim 14 further comprising the steps of
(a) reading data from a data containing device mounted on the spool or a pallet onto which the spool is mounted,
(b) transferring at least some of the data onto a bar code label,
(c) mounting the bar code label onto the spool or pallet, and
(d) moving the spool around the track segment transferred to.

18. The method of claim 14 further comprising a step of tensile screening of the optical fiber on a spool at one of the multiple non-interconnected track segments.

19. The method of claim 14 further comprising a step of performing a test at one of the multiple non-interconnected track segments, the test determining at least one optical property of the optical fiber.

20. The method of claim 14 wherein at least one of the plurality of pallets is propelled by an electrically powered truck which receives power from one or more power strips on a track segment.

21. The method of claim 14 wherein the first segment includes a first pallet and the second segment includes a second pallet, each pallet containing a data containing device and wherein at least a portion of information contained in the data containing device of the first pallet is transferred to the data containing device on the second pallet.

22. The method of claim 14 further comprising a step of performing a test of the optical fiber on a test track segment of the non-interconnected track segments, the test selected from a group consisting of:
(a) measurement of the optical attenuation using optical time domain reflectometry,
(b) measurement of the optical dispersion,
(c) measurement of fiber cut-off wavelength,
(d) glass,
(e) bow,
(f) gem, and
(g) PMD.

23. The method of claim 14 further comprising additional steps of:
(a) periodically automatically releasing a spool of calibration optical fiber into the test track segment,
(b) performing at least one test on the calibration optical fiber to check calibration of at least one testing apparatus within the test track segment.

24. The method of claim 23 further comprising a step of:
(a) rerouting any spools bound for the at least one testing apparatus when the calibration check indicates that the results are out of tolerance by more than a predetermined amount.

25. The method of claim 1 comprising an additional steps of:
supplying from a plurality of draw towers spools wound with optical fiber to a first track segment of the automated conveyor system; and
transporting the spools from the draw towers to an additional manufacturing process by the first track segment.

26. The method of claim 1 further comprising a step of providing on a first and a second track segment of the automated conveyor a plurality of pallets.

27. A method of manufacturing optical fiber, comprising the steps of:
drawing an optical fiber and winding the fiber on a spool on a draw apparatus,
loading the spool from the draw apparatus onto a first track segment of an automated conveyor system,
offloading the spool from the first track segment to a second track segment of an automated conveyor system,
performing a test on the optical fiber wound onto the spool,
transferring the spool onto a third track segment, and
loading the spool from the third track segment to a shipping package.

28. A method of manufacturing optical fiber, comprising the steps of:
drawing an optical fiber and winding the fiber onto a bulk spool on a draw apparatus,
loading the bulk spool from the draw apparatus onto a first track segment of an automated conveyor system,
winding the fiber on the bulk spool onto a plurality of shipping spools,
offloading the shipping spools onto a test track segment,
performing a test on the optical fiber on at least one of the shipping spools,
transferring the shipping spools onto a third track segment, and
loading the spools from the third track segment into one or more shipping packages.

29. An apparatus for manufacturing optical fiber, comprising:
a draw apparatus producing optical fiber that is wound onto a spool,
a first loading apparatus that transfers the spool from the draw apparatus onto a first track segment of an automated conveyor system, and
a second loading apparatus that transfers the spool from the first track segment onto a second track segment of the automated conveyor system, the second track segment including at least one test station adapted to perform a test on the fiber wound on the spool.

30. The apparatus of claim 29 further comprising another track segment including at least one automated load station adapted to load the spools into a shipment package.

31. The apparatus of claim 30 wherein the third track segment includes a plurality of sorting lanes into which spools of fiber are sorted.

32. The apparatus of claim 29 wherein the first and second track segments each include pallets mounted thereon which transport spools on the segments.

33. The apparatus of claim 32 wherein the pallets or spools have mounted thereon a data containing device adapted to carry data regarding the spool, data regarding the optical fiber wound onto the spool, or data on processing the optical fiber.

34. The apparatus of claim 33 wherein the data containing device is an electronic article.

35. The apparatus of claim 33 further the data containing device is a radio frequency chip.

36. The apparatus of claim 33 further comprising a spool database including data adapted to be downloaded to, or uploaded from, the data containing device.

37. The apparatus of claim 29 wherein the first and second track segments are non-interconnected.

38. The apparatus of claim 37 wherein each of the first and second non-interconnected track segments include a plurality of pallets adapted to circuit thereon.

39. The apparatus of claim 29 further comprising a bar code label mounted on the spool when circuiting around the second track segment, the bar code including data transferred from a data containing device mounted on a pallet of the first track segment the spool was transferred from.

40. The apparatus of claim 29 wherein the second track segment comprises a non-interconnected track segment wherein tensile screening of the optical fiber on the spool is performed.

42. The apparatus of claim 29 further comprising another non-interconnected track segment wherein a test of an optical property of the fiber on is performed.

43. The apparatus of claim 29 further comprising a plurality of pallets propelled by an electrically powered trucks, the plurality of pallets adapted to circuit around the first and second track segments.

44. The apparatus of claim 29 further comprising at least one test track segment on which is performed a test selected from a group consisting of:
(a) measurement of the optical attenuation using optical time domain reflectometry,
(b) measurement of the optical dispersion,
(h) measurement of fiber cut-off wavelength,
(i) glass,
(j) bow,
(k) gem, and
(l) PMD.

45. The apparatus of claim 29 further comprising a test track segment including at least one test apparatus and a spool of calibration optical fiber adapted to check a calibration of the at least one test apparatus.

46. The apparatus of claim 29 further comprising a defect area to which any defective spools are automatically rerouted.

47. The apparatus of claim 29 further comprising a plurality of draw towers supplying spools wound with optical fiber to the first track segment of the automated conveyor system.

48. An optical fiber manufacturing apparatus, comprising:
a plurality of draw apparatus producing optical fiber that is wound onto a plurality of spools,
a plurality of transfer apparatus that automatically transfer the spools from the plurality of draw apparatus onto a transfer track segment of an automated conveyor system, and
an offloading apparatus that automatically transfers the plurality of spools from the transfer track segment onto a test track segment of the automated conveyor system, the second track segment including at least one test station adapted to perform a test on the fiber wound onto at least one of the plurality of spools,
a receipt to stock transfer apparatus that automatically transfers the plurality of spools from the test track segment onto a shipping track segment of the automated conveyor system, and
a loading apparatus that that automatically transfers the plurality of spools from the shipping track segment into a shipment packaging.

49. An optical fiber manufacturing apparatus, comprising:
a plurality of draw apparatus producing optical fiber that is wound onto a plurality of empty spools to form wound spools,
a spool supply automatically providing the plurality of empty spools to the plurality of draw towers,
a plurality of transfer apparatus that automatically transfer the wound spools from the plurality of draw apparatus onto a transfer track segment of an automated conveyor system, and
an offloading apparatus that automatically transfers the wound spools from the transfer track segment onto a test track segment of the automated conveyor system, the test track segment including at least one test station adapted to perform a test on the fiber wound onto at least one of the wound spools,
a receipt to stock transfer apparatus that automatically transfers the plurality of spools from the test track segment onto a shipping track segment of the automated conveyor system, and
a loading apparatus that that automatically transfers the wound spools from the shipping track segment into a shipment packaging.

50. An optical fiber manufacturing apparatus, comprising:
a plurality of draw apparatus producing optical fiber that is wound onto a plurality of empty bulk spools to form wound bulk spools,
at least one first transfer apparatus that transfers the wound bulk spools from the plurality of draw apparatus onto a first track segment of an automated conveyor system, the first track segment transporting the wound bulk spools to a location where they may be transferred to a second track segment, and
at least one second transfer apparatus that transfers the wound bulk spools from the first track segment onto the second track segment of the automated conveyor system, the second track segment including at least one station adapted to perform a tensile test on the fiber wound onto at least one of the wound bulk spools and to rewind the fiber on the wound bulk spools onto shipping spools,
at least one third transfer apparatus that transfers the shipping spools onto a third track segment, the third track segment including at least one test station that is adapted to perform at least one optical test of the fiber wound on at least one of the shipping spools,
at least one fourth transfer apparatus that transfers the plurality of spools from the third track segment onto a fourth track segment of the automated conveyor system, the fourth track segment adapted to perform operations to ready the shipping spools for shipment, and
at least one fifth transfer apparatus that that transfers the shipping spools from the fourth track segment into a shipment packaging.
